(19) United States
(12) Patent Application Publication
(10) Pub. No.: US 2009/0201484 A1
(43) Pub. Date: Aug. 13, 2009

(54) Utilities supply member connection apparatus, stage apparatus, projection optical system support apparatus and exposure apparatus

(75) Inventor: Dai Arai, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/289,377

(22) Filed: Oct. 27, 2008

Related U.S. Application Data
(60) Provisional application No. 60/996,237, filed on Nov. 7, 2007.

(30) Foreign Application Priority Data
Oct. 29, 2007 (JP) 2007-280623

(51) Int. Cl. G03B 27/58

(52) U.S. Cl. 355/72

(57) ABSTRACT

A connection apparatus for a utilities supply member, comprises: a holding part (41), a drive apparatus (43), a measuring apparatus (47), and a control apparatus. The holding part (41) is supported to freely move relative to a first member (CL) and holds a part of a utilities supply member (TB) connected between the first member (CL) and a second member (15). The drive apparatus moves the holding part (41) relative to the first member (CL). A measuring apparatus (47) obtains information relating to the relative position between the holding part (41) and the second member (15). The control apparatus controls the drive apparatus (43) based on the measurement results of the measuring apparatus (47).

### CROSS-REFERENCE TO RELATED APPLICATION

This application is a non-provisional application claiming priority to and the benefit of U.S. provisional application No. 60/996,237, filed Nov. 7, 2007, and claims priority to Japanese Patent Application No. 2007-280623, filed Oct. 29, 2007. The entire contents of which are incorporated herein by reference.

### BACKGROUND

1. Field of the Invention

The present invention relates to a utilities supply member connection apparatus, a stage apparatus, a projection optical system support apparatus, and an exposure apparatus.

2. Related Art

In manufacturing semiconductor devices, etc., a projection exposure apparatus that transfers the image of the pattern of a reticle as a mask to the respective shot regions on a wafer (or a glass plate, etc.) that has been coated with a resist as a substrate via a projection optical system is used. Conventionally, step-and-repeat system (full-field exposure type) projection exposure apparatuses (steppers) have been widely used as the projection exposure apparatus. Recently scanning exposure type projection exposure apparatuses (scanning type exposure apparatuses) such as step-and-scan systems that synchronously scan a reticle and a wafer with respect to a projection optical system to perform exposure are also becoming a subject of attention.

In conventional exposure apparatuses, the drive parts of the reticle stage and the wafer stage that respectively support and transport a reticle, which is a pattern original plate, and a wafer, to which that pattern is transferred, are secured to a structural body that supports the projection optical system, and the projection optical system is also such that the vicinity of the center of gravity is secured to that structural body. In addition, in order to position the wafer stage with high accuracy, the position of the wafer stage is measured by a laser interferometer, and a movable mirror for the laser interferometer is attached to the wafer stage.

In conventional exposure apparatuses such as the above, the drive part, such as the wafer stage, and the projection optical system are secured on the same structural body, so vibration produced by means of the stage driving reaction force is transmitted to the structural body, and vibration is also further transmitted to the projection optical system. In addition, since all of the mechanical structures mechanically resonate with respect to vibration of a prescribed frequency, when such a vibration was transmitted to that structural body, there were drawbacks in that deformation of the structural body or resonance phenomena were caused, and positional misalignment of the transfer pattern or a decrease in contrast occurred.

In PCT International Publication No. WO 2006/038952, technology is disclosed that restricts the vibration that is transmitted to the projection optical system using a relatively simple mechanism by comprising a support member, which supports the projection optical system, and a linking member, which supports the projection optical system on a frame in a suspended manner via the support member.

However, problems such as those below are present in the prior art discussed above.

Various wiring and piping (so-called feed wiring and piping; hereunder referred to as utilities supply members) for supplying utilities such as electric power and signals, which are supplied to the actuators and various sensors used by the projection optical system, as well as coolant are connected between the frame and the support member.

For that reason, as discussed above, even if a configuration in which vibrations transmitted to the projection optical system are suppressed by supporting the projection optical system in a suspended manner were to be employed, there would be a possibility of stress resulting from a slight displacement difference produced between the support member and the frame being transmitted via a utilities supply member.

In addition, there is also a possibility that external disturbances such as floor vibration, etc. would be transmitted to the support member via the utilities supply member, thereby producing stress.

In the case in which stress attributable to the presence of the utilities supply member has unfortunately slightly deformed the body and has caused the interferometer system (measuring system) to vibrate, stage accuracy (the position information measurement accuracy of a substrate such as a wafer held by the stage) will unfortunately deteriorate.

The accuracy required of exposure apparatuses is becoming higher year by year, and the effects of stress attributable to the presence of the utilities supply members can no longer be ignored.

A purpose of some aspects of the present invention is to provide a utilities supply member connection apparatus, which is able to restrict adverse effects attributable to the presence of a utilities supply member, as well as a stage apparatus, a projection optical system support apparatus, and an exposure apparatus.

### SUMMARY

According to a first aspect of the present invention, there is provided a connection apparatus for a utilities supply member, the connection apparatus comprising: a holding part, which is supported to freely move relative to a first member and holds a part of the utilities supply member connected between the first member and a second member; a drive apparatus, which moves the holding part relative to the first member, a measuring apparatus, which obtains information relating to the relative position between the holding part and the second member, and a control apparatus, which controls the drive apparatus based on the measurement results of the measuring apparatus.

Therefore, in the first aspect, in a case in which a slight displacement difference has occurred between the first member and the second member, a slight displacement difference is produced between the holding part, which holds the utilities supply member, and the second member, but by measuring this slight displacement difference by means of the measuring apparatus and driving the holding part by an amount of movement that would correct the aforementioned slight displacement difference via the drive apparatus by means of the control apparatus, it is possible to set the relative displacement of the holding part and the second member to zero to maintain the relative positional relationship of these in a fixed status. For this reason, stress attributable to a slight displacement difference produced between the first member and the second member is not produced in the utilities supply member positioned between the holding part and the second member, and it is possible to restrict adverse influences that the stress has on the second member. In addition, in the first aspect, the reaction force at the time of driving of the holding part is not transmitted to the second member; for example, in the case in which the drive apparatus has been provided on the first member, said first member bears the load, and this reaction force can be restricted from having an adverse influence on the second member.

According to a second aspect of the present invention, there is provided a stage apparatus comprising a base frame, which supports a base member; a movable stage, which moves above the base member; and the above-mentioned connection apparatus, which is for connecting a utilities supply member between the base frame and the base member.

Therefore, in the second aspect, in the case in which a slight displacement difference has been produced between the base frame and the base member, it is possible to set the relative displacement between the holding part and the base member to zero to maintain the relative positional relationship of these in a fixed status. For this reason, stress attributable to a slight displacement difference produced between the base frame and the base member is not produced in the utilities supply member positioned between the holding part and the base member, and it is possible to restrict this stress from exerting adverse influence upon the base member, that is, the movement characteristics of the movable stage.

According to a third aspect of the present invention, there is provided a stage apparatus comprising: a movable stage, a substage, which moves synchronously with the movable stage; and the above-mentioned connection apparatus, which is for connecting a utilities supply member between the substage and the movable stage.

Therefore, in the third aspect, in the case in which a slight displacement difference is produced between the movable stage and the substage, it is possible to set the relative displacement between the holding part and the movable stage to zero to maintain the relative positional relationship of these in a fixed status. For this reason, stress attributable to a slight displacement difference produced between the movable stage and the substage is not produced in the utilities supply member positioned between the holding part and the movable stage, and it is possible to restrict this stress from exerting adverse influence upon the movement characteristics of the movable stage.

According to a fourth aspect of the present invention, there is provided a support apparatus of a projection optical system, the support apparatus comprising: a base member, which support the projection optical system; a base frame, which supports the base member; and the above-mentioned connection apparatus, which is for connecting a utilities supply member between the base frame and the base member.

Therefore, in the fourth aspect, in a case in which a slight displacement difference is produced between the base frame and the base member, it is possible to set the relative displacement between the holding part and the base member to zero to maintain the relative positional relationship of these in a fixed status. For this reason, stress attributable to a slight displacement difference produced between the base frame and the base member is not produced in the utilities supply member positioned between the holding part and the base member, and it is possible to restrict this stress from exerting adverse influence upon the projection characteristics of the projection optical system.

According to a fifth aspect of the present invention, there is provided that comprises the above-mentioned stage apparatus or the above-mentioned connection apparatus of a projection optical system.

Therefore, in the fifth aspect, it is possible to restrict adverse influences from being exerted upon the movement characteristics of the movable stage and the projection characteristics of the projection optical system, and it is possible to realize high accuracy exposure processing.

According to some aspects of the present invention, it is possible to restrict adverse influences attributable to the presence of a utilities supply member.

### BRIEF DESCRIPTION OF THE DRAWINGS

FIG. 1 is a schematic view that shows the configuration of an exposure apparatus relating to the first embodiment.

FIG. 2 is a drawing that shows the details of a utilities supply member connection apparatus.

FIG. 3 is a plan view that shows the schematic configuration of the same connection apparatus.

FIG. 4 is a drawing that shows the details of the connection apparatus relating to the second embodiment.

FIG. 5 is a drawing that shows the details of the connection apparatus relating to the third embodiment.

FIG. 6 is an oblique view of a wafer stage relating to the fourth embodiment.

FIG. 7 is a drawing that shows the details of the connection apparatus relating to the fourth embodiment.

FIG. 8 is a flow chart that shows an example of a manufacturing process of the microdevice.

FIG. 9 is a drawing that shows an example of the detailed process of step S13 in FIG. 8.

### DESCRIPTION OF EMBODIMENTS

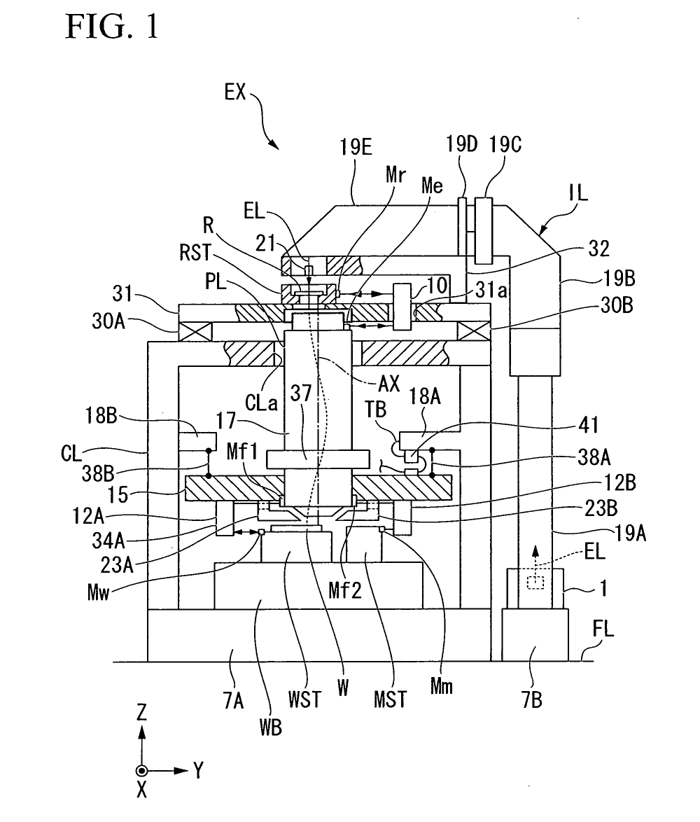

Embodiments of the utilities supply member connection apparatus, stage apparatus, projection optical system support apparatus and exposure apparatus of the present invention will be described below while referring to FIG. 1 through FIG. 9.

### First Embodiment

In the present embodiment, a description will be given regarding a utilities supply member connection apparatus relating to the present invention applied to a utilities supply member connected between a metrology frame, which supports a projection optical system in an exposure apparatus, and a main body column.

FIG. 1 is a drawing that shows the schematic configuration of an exposure apparatus EX relating to the first embodiment of the present invention.

The exposure apparatus EX shown in this drawing is a step-and-scan system scanning type exposure apparatus, specifically, a scanning stepper, that synchronously moves a reticle R and a wafer W in a one-dimensional direction while transferring a pattern formed on the reticle R onto the respective shot regions on the wafer W.

In the description below, if necessary, an XYZ rectangular coordinate system will be set up in the drawing, and the positional relationships of the respective members will be described while referring to this XYZ rectangular coordinate system. The XYZ rectangular coordinate system shown in FIG. 1 is such that the X axis and the Y axis are set so as to be included in a plane parallel to the movement plane of the wafer W, and the Z axis is set in a direction along the optical axis AX of the projection optical system PL. In addition, in the present embodiment, the direction (scanning direction) in which the reticle R and the wafer W are synchronously moved is set to the Y directions.

This exposure apparatus EX has an illumination optical system IL, which is mounted on a floor surface FL via large and small pedestals 7A and 7B and illuminates the reticle R by means of exposure light EL, a reticle stage RST that holds the reticle R and is able to move, a projection optical system PL that projects exposure light EL that emerges from the reticle R onto the wafer W, a wafer stage WST that holds the wafer W and is able to move, a measuring stage MST, and a main unit column (base frame) CL, which holds the projection optical system PL and on which the wafer stage WST is mounted, and it has a control apparatus, etc. that is not shown that comprehensively controls the exposure apparatus EX.

The illumination optical system IL is an optical system that illuminates the reticle R supported by the reticle stage RST using the exposure light EL. This illumination optical system IL has a homogenizing optical system, which homogenizes the illumination intensity of the exposure light EL that emerges from an exposure light source 1 provided on the small pedestal 7B, a beam splitter, a variable dimmer for quantity of light adjustment, a mirror, a relay lens system (these are arranged within illumination system chambers 19A and 19B), a reticle blind (arranged at the emergence end 19C and the incidence end 19D), which sets the illumination region resulting from the exposure light EL on the reticle R to a slit shape, and an imaging lens system (arranged within an illumination system chamber 19E) and is capable of illumination of a prescribed illumination region on the reticle R using exposure light EL with a uniform illumination intensity distribution. Used as the exposure light EL that emerges from the exposure light source are, for example, ultraviolet light such as ultraviolet range bright lines (g lines, h lines, i lines) that emerge from a mercury lamp, KrF excimer laser light (wavelength of 248 nm), and ArF excimer laser light (wavelength of 193 nm).

The reticle stage RST is a stage apparatus, which is supported on the reticle base 31 via air bearings that are not shown and supports the reticle R while performing adjustment of two-dimensional movement within an XY plane orthogonal to the optical axis AX of the projection optical system PL and of the angle of rotation in the Z directions. The position of the reticle R supported on the reticle stage RST in the XY direction and the angle of rotation in the Z directions is measured in real time by, for example, a laser interferometer 10, a movable mirror Mr and a reference mirror Me, and the measurement results thereof are output to a control apparatus that is not shown. A drive apparatus that is not shown comprised of, for example, a linear motor is provided on the reticle stage RST, and by means of the control apparatus controlling that drive system based on the measurement results of the laser interferometer 10, positioning of the reticle R supported by the reticle stage RST is performed. The reticle base 31 is supported by the main body column CL via vibration isolating apparatuses 30A and 30B. A column 32 that supports the illumination system chamber 19E is provided on the reticle base 31. An opening part, which allows the exposure light EL that emerges from the illumination system chamber 19E to pass through, is provided at the front end of the column 32, and a pair of alignment systems 21 are provided at both end parts in the X directions with respect to the optical path of the exposure light EL within this opening part. A recessed part for accommodating the upper part of the projection optical system PL is formed at the center part bottom surface of the reticle base 31, and an opening part, which allows the exposure light EL to pass through, is formed in this recessed part.

The projection optical system PL is an optical system that projection exposes a pattern formed on the reticle R onto a wafer W at a prescribed projection magnification, and it has a configuration such that a plurality of optical elements are accommodated within a lens barrel 17. The upper part of the projection optical system PL passes through the interior of an opening part CLa of the upper part of the main body column CL and is accommodated in the aforementioned recessed part of the reticle base 31. In the present embodiment, the projection optical system PL is a reduction system in which the projection magnification P is, for example, ¼ or ⅕. This projection optical system PL may also be a unity magnification system or an enlargement system.

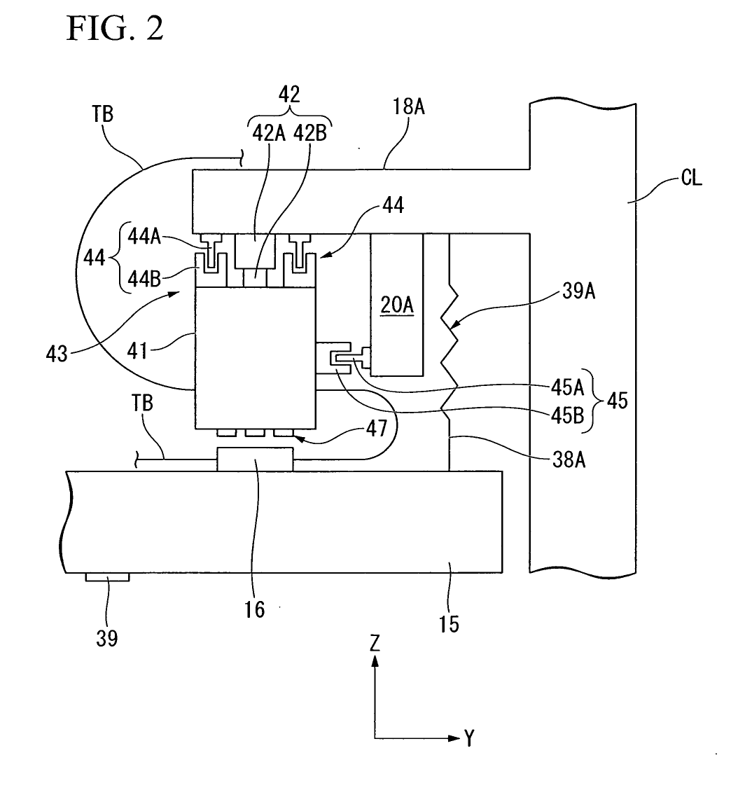

The lower end side (downstream side of the exposure light EL) of the lens barrel 17 is such that the lens barrel 17 is fixed by a flange part 37 by means of a metrology frame (second member, base member) 15 that, for example, has a flat plate shape in a planar view. The metrology frame 15 is supported by suspending via suspension members 38A˜38C (in FIG. 1, 38C is not shown) at three locations of the frames 18A˜18C (in FIG. 1, 18C is not shown) provided to protrude from the main unit column CL. In addition, vibration isolating apparatuses 39A˜39C (see FIG. 2; in FIG. 2, only 39A is shown) for alleviating vibration in the Z directions, which is the optical axis direction of the projection optical system PL, are provided between suspension members 38A˜38C and the frame 18.

An encoder head 39 (see FIG. 2), which measures the position of the wafer stage WST by measuring an encoder scale (not shown) provided on the wafer stage WST, is provided at the side opposite the wafer stage WST on this metrology frame 15.

Various utilities supply members TB, for supplying utilities such as electric power and signals supplied to the actuator and various sensors (the encoder head 39, etc.) used by the projection optical system PL as well as coolant, etc., are connected between the metrology frame 15 and frame 18A (main body column CL; first member). As shown in FIG. 2, the utilities supply member TB is secured to a fixed part 16 provided on the metrology frame 15, and the utilities supply member TB, which leads from frame 18A toward the metrology frame 15 (fixed part 16), is held by a holding member (holding part) 41 supported via a dead load support part (support apparatus) 42 supported in a hanging manner on said frame 18A and is relayed.

Note that it is preferable that the bending rate when pulling around the utilities supply member TB be small in order to restrict stress, etc. that is transmitted to the metrology frame 15 via the utilities supply member TB.

The dead load support part 42 has a cylinder part 42A linked to frame 18A and a piston part 42B, which is linked to the holding part 41 while being inserted into the interior of the cylinder part 42A and being able to move relative to the cylinder part 42A, and it urges the piston part 42P upward in the gravitational direction by setting the interior of the cylinder part 42A to vacuum pressure. Specifically, the dead load support part 42 uses vacuum pressure to have an urging force corresponding to the dead load of the holding member 41 to support the holding member 41, and it supports the holding member 41 to be able to move freely with respect to frame 18A (main body column CL) with six degrees of freedom, which are the X directions, the Y directions, the Z directions, the θX directions, the θY directions and the θZ directions.

Note that the detailed configuration of a dead load support part 42 is described in detail as a dead load canceller in, for example, Japanese Unexamined Patent Application Publication No. 2004-311459.

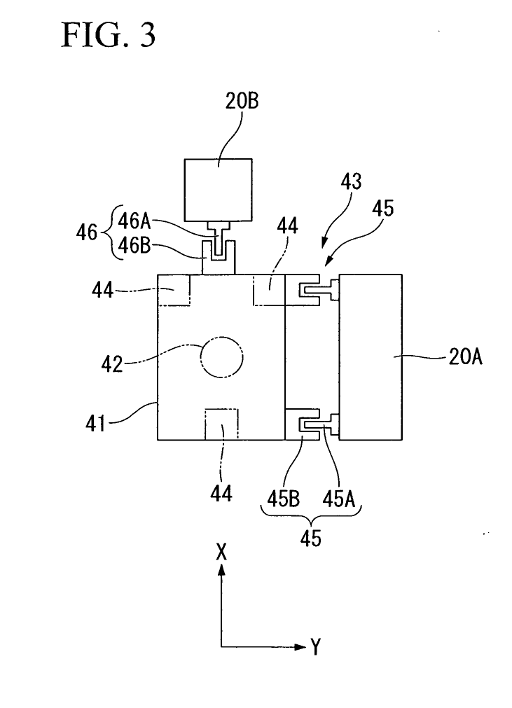

In addition, the holding member 41 is driven in directions with six degrees of freedom with respect to frame 18A by means of a drive apparatus 43. This drive apparatus 43, as shown in FIG. 2, comprises a Z motor 44, which drives the holding member 41 in the Z directions, a Y motor 45, which drives the holding member 41 in the Y directions, and, as shown in FIG. 3, an X motor 46, which drives the holding member 41 in the X directions. The Z motor 44 comprises, for example, a voice coil motor that comprises a stator 44A, which is provided on the frame 18A and has an armature, and a mover 44B, which is provided on the holding member 41 and has a magnetic body, and mover 44B moves in the Z directions with respect to stator 44A by means of electromagnetic interaction between stator 44A and mover 44B. In addition, the Z motor 44, as shown in FIG. 3, is arranged at three locations having the dead load support part 42 as the center of gravity position in a planar view. Then, by driving the three Z motors 44 in an identical direction by an identical amount, the holding member 41 is driven in the Z directions, and by varying the drive amount (or the drive direction) of the three Z motors 44, the holding part 41 is driven in the θX directions and the θY directions.

Similarly, the Y motor 45 is, for example, a voice coil motor, comprising a stator 45A, which is provided on a frame 20A provided to hang from the frame 18A at the +Y side of the holding member 41 along the −Z direction, and a mover 45B, which is provided on the holding member 41 and has a magnetic body, and mover 45B moves in the Y directions with respect to stator 45A by means of the electromagnetic interaction between stator 45A and mover 45B. In addition, the Y motor 45, as shown in FIG. 3, is arranged in a total of two locations at an interval in the X direction. In addition, by driving the two Y motors 45 in an identical direction by an identical amount, the holding member 41 is driven in the Y directions, and by varying the drive amount (or the drive direction) of the two Y motors 45, the holding part 41 is driven in the OZ directions.

Also, the X motor 46 is, for example, a voice coil motor, comprising a stator 46A, which is provided on a frame 20B provided to hang from the frame 18A at the +X side of the holding member 41 along the −Z direction, and a mover 46B, which is provided on the holding member 41 and has a magnetic body, and by mover 46B moving in the Y directions with respect to stator 46A by means of the electromagnetic interaction between stator 46A and mover 46B, the holding member 41 is driven in the X directions.

In addition, a sensor (measuring apparatus) 47 is provided, which measures the relative position of the holding member 41 and the metrology frame 15 in directions with six degrees of freedom by measuring the position of the fixed part 16 at the side opposing the metrology frame 15 of the holding member 41. The measurement result of the sensor 47 is output to a control apparatus, and the control apparatus controls driving of the aforementioned drive apparatus 43 based on the input measurement result.

In addition, provided on the metrology frame 15 are a laser interferometer 12A, a laser interferometer 12B, and an alignment system that is not shown.

Secured to the lower surface of the metrology frame 15 are a projection optical system 23A, which projects a slit image to a plurality of measurement points on the surface of the wafer W, and a light receiving optical system 23B, which receives reflected light from that surface to detect information relating to the amount of horizontal misalignment of reimaging of the slit images.

The wafer stage WST is supported by air bearings on the wafer base plate WB, and it is such that it holds the wafer W while being guided so that it is able to move within the XY plane. This wafer stage WST is able to move in directions with three degrees of freedom, which are the X directions, the Y directions and the OZ directions, by means of a linear motor that is not shown. The position of the wafer stage WST in the X directions, the Y directions and the OZ directions is measured in real time by laser interferometer 12A, a movable mirror Mw, and a reference mirror Mf1, and the measurement result is output to the control apparatus.

The measuring stage MST, similarly to the wafer stage WST, is supported by air bearings on the wafer base plate WB and is supported and guided so that it is able to move within the XY plane on the wafer base plate WB by means of a linear motor that is not shown. The position of the measuring stage MST in the X directions, the Y directions and the OZ directions is measured in real time by laser interferometer 12B, a movable mirror Mm, and a reference mirror Mf2, and the measurement result is output to the control apparatus.

Next, operation of the exposure apparatus EX configured in the above way will be described.

The exposure light EL that has emerged from the exposure light source 1 illuminates a reticle R on which a pattern is formed after rectification to the required size and illumination intensity uniformity has been performed in an illumination optical system IL comprising various lenses and mirrors, etc., and this pattern formed on the reticle R is reduction transferred to the respective shot regions on the wafer W held on the wafer stage WST via the projection optical system PL.

Here, in the above exposure processing, vibration and stress from the vicinity that is transmitted from the main body column CL to the metrology frame 15 via suspension members 38A˜38C are shielded by vibration isolating apparatuses 39A˜39C. In addition, since a drive member is not built into the metrology frame 15, vibrations transmitted to the projection optical system PL via the metrology frame 15 are greatly restricted.

On the other hand, in the exposure apparatus EX, since there is a possibility that external disturbances such as the vibration and stress from the vicinity will be transmitted from the main body column CL to the metrology frame 15 via a utilities supply member TB, in the present embodiment, external disturbances transmitted via the aforementioned utilities supply member TB are removed by means of an external disturbance removal mechanism comprising the holding member 41, the dead load support part 42, the drive apparatus 43 and the sensor 47.

Specifically, first, by using the sensor 47 to measure the position of the fixed part 16 (the position in the aforementioned directions with six degrees of freedom; reference position) in advance, the relative positional relationship (reference position relationship) of the holding member 41 and the fixed part 16 is measured and stored. Through this, the shape (bending status) of the utilities supply member TB, which is suspended between the holding member 41 and the fixed part 16 and is dependent upon the relative positional relationship of this holding member 41 and fixed part 16 is indirectly stored.

Then, after exposure processing has started, position measurement of the fixed part 16 by the sensor 47 continues to be implemented, and, at the measured position of the fixed part 16 (specifically, the position of the metrology frame 15), in the case in which displacement has occurred with respect to a reference position that has been measured in advance, that is, in the case in which the displacement has occurred between the holding member 41 and the metrology frame 15 during exposure processing, the control apparatus moves the holding member 41 so that the produced displacement is corrected by appropriately selecting and driving the Z motors 44, the Y motors 45 and the X motor 46 of the drive apparatus 73 according to the direction in which displacement has occurred. Through this, the relative positional relationship of the holding member 41 and the fixed part 16 (metrology frame 15) is held (maintained).

In this way, in the present embodiment, even in the case in which deformation occurs in a utilities supply member TB connected between the main body column CL and the metrology frame 15 and displacement is produced between the holding frame 41 and the fixed part 16 by external disturbance being added from the main body column CL to a utilities supply member TB, said displacement is measured, and driving of the holding member 41 is performed so that this displacement is immediately corrected, so it is possible to always fixedly maintain the relative positional relationship between the holding member 41 and the metrology frame 15 by means of the stress, etc. accompanying displacement being borne by the metrology frame 15. Therefore, in the present embodiment, it is possible to fixedly maintain the shape (bending status) of a utilities supply member TB connected between the holding member 41 and the fixed part 16, and it is possible to restrict stress produced by said utilities supply member TB deforming from being transmitted to the metrology frame 15 and exerting adverse influence upon the projection characteristics of the projection optical system PL supported by said metrology frame 15.

In addition, in this way, in the present embodiment, the causes of external disturbance attributable to utilities supply members TB can be eliminated, so it is possible to dramatically improve the vibration shielding performance resulting from vibration isolating apparatuses 39A˜39C.

Moreover, the reaction force when the holding member 41 is driven at the time of correction of the aforementioned displacement is generated by noncontact thrust resulting from a drive apparatus 43 provided on the main body column CL, so a load is not applied to the metrology frame 15, and it is possible to avoid adverse influence being exerted upon the projection characteristics of the aforementioned projection optical system PL.

In addition, in the present embodiment, since the holding member 41 is supported by the dead load support part 42, it is no longer necessary to support the dead load of the holding member 41 by means of the thrust of the Z motors 44, and it becomes possible to greatly restrict the power consumption and heat generation accompanying driving of the Z motors 44, and it becomes possible to reduce factors such as air turbulence to contribute to improvement of exposure accuracy.

Furthermore, in the present embodiment, since the metrology frame 15 is supported in a suspended manner on the main unit column CL (frames 18A 18C) via suspension members 38A˜38C and vibration isolating apparatuses 39A˜39C, it is possible to easily maintain a status in which the projection optical system PL and the metrology frame 15 are assembled in a module system and adjusted even after assembly, so, as a result, it is possible to shorten the accuracy check process after assembly, and it is also possible, at the time of replacement of the projection optical system PL and/or the metrology frame 15 at an exposure apparatus EX manufacturing plant or a semiconductor device manufacturing plant, to shorten the adjustment process (return process) after replacement, since the possibility of bringing about changes to the adjustment status of other portions is effectively eliminated.

### Second Embodiment

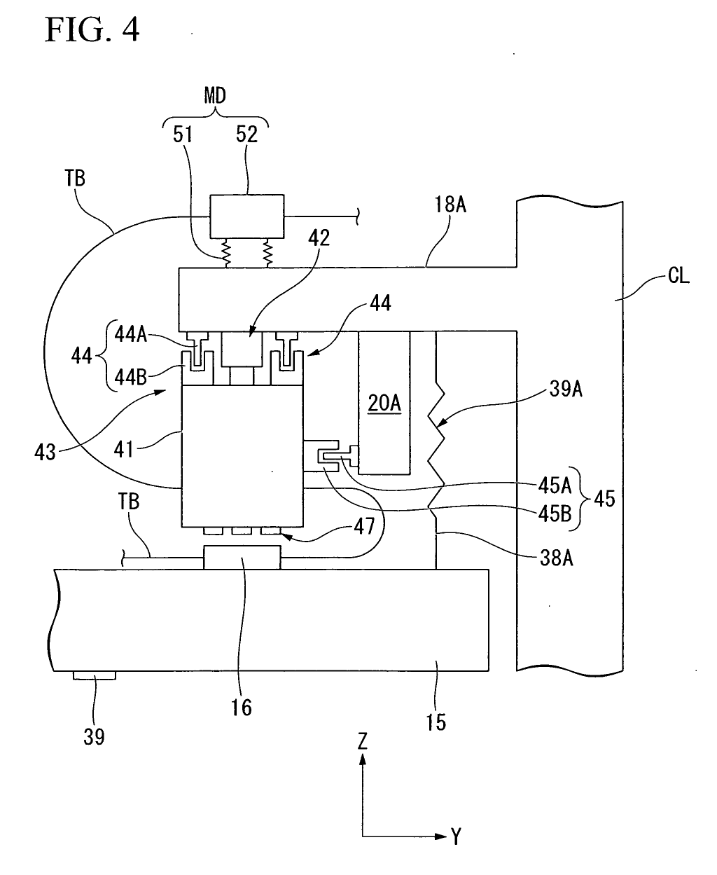

Next, a second embodiment will be described while referring to FIG. 4.

Note that, in this figure, identical symbols are assigned to elements that are identical to the constituent elements of the first embodiment shown in FIG. 1 through FIG. 3, and descriptions thereof are omitted.

In the above first embodiment, the configuration was such that the utilities supply member TB was directly connected from the main body column CL to the holding member 41, but, in the present embodiment, a description will be given with respect to a configuration in which connection to the holding member 41 is performed via a mass apparatus.

As shown in FIG. 4, in the present embodiment, a mass apparatus MD is provided on frame 18A. This mass apparatus MD comprises an elastic body 51, which has low rigidity and is provided on frame 18A as the main body part, and a mass body 52 connected to frame 18A via the elastic body 51. The mass body 52 is connected to a utilities supply member TB that leads from the main body column CL toward the holding member 41, and it relays this utilities supply member TB. This elastic body 51 and mass body 52 comprise a vibration system and are subject to coupled vibration by means of vibration of the utilities supply member TB.

Therefore, it is possible to reduce the vibration energy of the utilities supply member TB by means of the vibration system of the mass apparatus MD being excitated by vibration of the utilities supply member TB.

The rest of the configuration is similar to that of the aforementioned first embodiment.

In the aforementioned first embodiment, among the vibration transmitted from the exterior via the utilities supply member TB, it is only possible to correct relatively low frequency components (for example, several tens Hz or less) using the relationship between the response frequencies of the sensor 47 and the drive apparatus 43, but, in the present embodiment, it also becomes possible to remove high frequency components corresponding to the characteristic frequency of the vibration system in the mass apparatus MD. Also, the elastic body 51 functions as a low pass filter that cuts the high frequency component of the vibration that is directly transmitted from frame 18A.

Therefore, in the present embodiment, in addition to it being possible to obtain operation and effects similar to those of the aforementioned first embodiment, it is possible to reduce vibration transmitted via the utilities supply member TB spanning a wide frequency range from the low frequency component to the high frequency component, it is possible to more effectively remove external disturbance factors attributable to the utilities supply member TB, and it is possible to prevent a decrease in exposure accuracy attributable to vibration.

Note that, it is also possible to make the mass body 52 a manifold apparatus for plurally distributing and branching the utilities supply member TB (here, gas is assumed to be the utility). In this case, it is no longer necessary to provide separate mass bodies, and it is possible to contribute to making the apparatus more compact and lower in cost. In addition, for the mass body 52, it is also possible to assume a case in which an electric cable is used in the utilities supply member TB and to use a connector used in connection of that electric cable.

### Third Embodiment

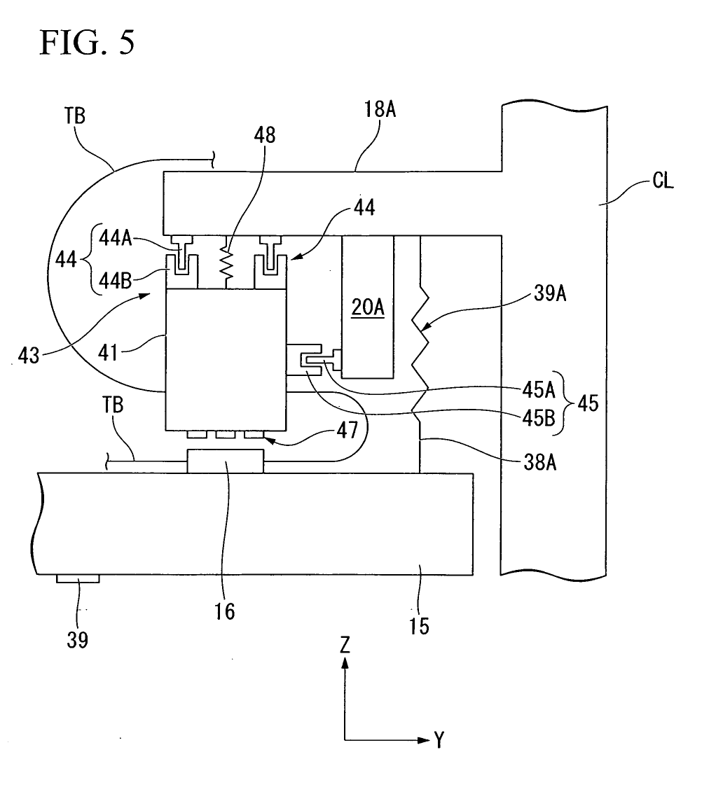

Next, a third embodiment will be described while referring to FIG. 5.

Note that, in this figure, identical symbols are assigned to elements that are identical to the constituent elements of the first embodiment shown in FIG. 1 through FIG. 3, and descriptions thereof are omitted.

In the above first embodiment, the configuration was such that the holding member 41 was supported by the dead load support part 42, but, in the present embodiment, an elastic member (in the present embodiment, a coil spring) 48 that has low rigidity is used as the support apparatus to support the holding member 41 to freely move with six degrees of freedom.

This coil spring 48 is such that one end is supported by frame 18A, and the other end is connected to the support member 41, and the rigidity (spring constant) is set so that it is possible to support the dead load of the holding member 41 and so that the characteristic frequency (frequency) of a vibration system formed by said coil spring 48 and the holding member 41 becomes sufficiently lower (smaller) than the servo response frequency resulting from the Z motors 44, the Y motors 45 and the X motor 46 that comprise the drive apparatus 43.

The rest of the configuration is similar to that of the aforementioned first embodiment.

In the present embodiment, with regard to the high frequency portion of the vibration transmitted from the exterior via a utilities supply member TB, due to the fact that the coil spring 48 acts as a low pass filter, it is possible to shield the vibration of this component, it is possible perform correction with respect to the low frequency component by means of the drive apparatus 43, and it is possible to realize actions similar to those of the dead load support part 42 described in the first and second embodiments using a simple configuration, and it is possible to pursue cost reductions.

Note that, in the present embodiment, a coil spring was used as the elastic member, but it is not limited to this, and it is also possible to appropriately use a leaf spring, rubber, etc.

### Fourth Embodiment

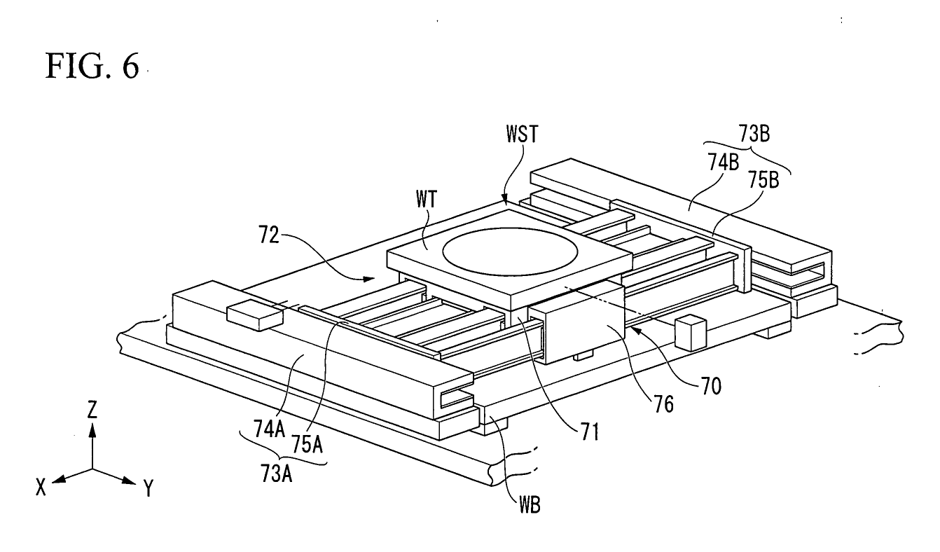

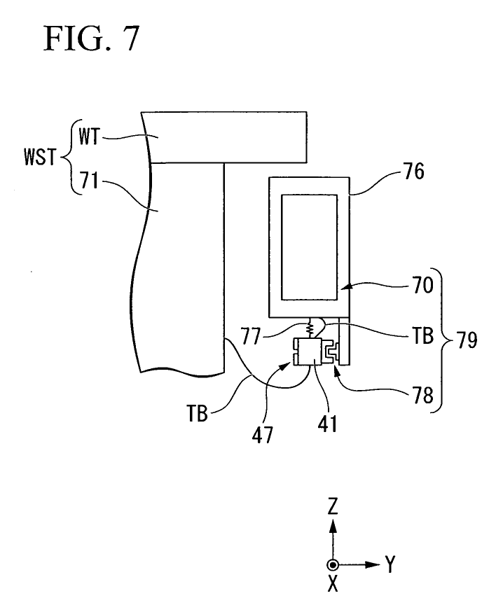

In the aforementioned first through third embodiments, a description was given in which a utilities supply member connection apparatus relating to the present invention was applied to a utilities supply member TB connected between a metrology frame 15 and a main body column CL, but, in the present embodiment, a description will be given with respect to an example in which it is applied to a utilities supply member connected between a wafer stage and a tube carrier that moves synchronously (following movement) with this wafer stage while referring to FIG. 6 and FIG. 7.

Note that, in these drawings, identical symbols are assigned to elements that are identical to the constituent elements of the first embodiment shown in FIG. 1 through FIG. 3, and descriptions thereof are omitted.

The wafer stage (stage apparatus) WST shown in FIG. 6 comprises a wafer table WT, which holds the wafer W, and an XY stage (movable stage, second member) 71, which is supported by the wafer base plate WB and continuously moves in the Y axis directions in unison with the wafer table WT by means of a drive apparatus such as a linear motor while step moving in the X axis directions and also being capable of fine movement in the OZ directions. A plurality of actuators such as voice coil motors are provided between the wafer table WT and the XY stage 71, and by driving these actuators, the wafer table WT is capable of fine movement in three directions, which are the Z axis directions, the θX directions and the θY directions, with respect to the XY stage 71 and has six degrees of freedom overall.

The drive apparatus that drives the XY stage 71 drives the XY stage 71 in the X directions using a long stroke, and comprises a first drive system 72, which performs fine driving in the Y directions and the Z directions as well as θx, θy and θz, and second drive systems 73A, 73B, which drive the XY stage 71 and the first drive system 72 in the Y directions using a long stroke. Second drive system 73A comprises a stator 74A, which extends in the Y direction, and a mover 75A. Second drive system 73B comprises a stator 74B, which extends in the Y direction, and a mover 75B. In addition, the aforementioned first drive system 72 is provided between movers 75A and 75B.

In addition, a tube carrier (first member) 76 is provided on the second drive systems 73A, 73B as a substage that moves in unison with the wafer stage WST in relation to the Y axis directions and moves by following (synchronizing with) the wafer stage WST by means of the driving of the X linear motor 70 in relation to the X directions. The tube carrier 76 relays a utilities supply member TB (see FIG. 7) connected to the wafer stage (second member) WST, such as electric wiring or air supply pipes.

In addition, in the present embodiment, as shown in FIG. 7, the holding member 41, which relays and holds the utilities supply member TB, is provided between the wafer stage WST and the tube carrier 76. This holding member 41 is supported (suspended) to freely move with six degrees of freedom with respect to the tube carrier 76 via a support apparatus 77 such as a dead load support part 42, which is the dead load canceller discussed above, or a coil spring 48.

This holding member 41 moves in the Z directions, the θX directions and the θY directions by means of the driving of a Z motor that is not shown, and, by means of the driving of the Y motor 78, moves in the Y directions and the OZ directions. Moreover, the holding member 41 moves in the X directions in unison with the tube carrier 76 by means of the driving of the X linear motor 70. Therefore, the holding member 41 is able to move relatively with six degrees of freedom with respect to the wafer stage WST.

The sensor 47, which measures without contact the relative position of the holding member 41 and the wafer stage WST in directions with six degrees of freedom by measuring the position of the wafer stage WST, is provided at the side that opposes the wafer stage WST (XY stage 71) of the holding member 41. The measurement result of this sensor 47 is output to the control apparatus, and the control apparatus controls driving of a drive apparatus 79, which comprises the aforementioned Z motor, Y motor 78 and X motor 70, based on the input measurement result.

In the aforementioned wafer stage WST, there is a possibility that displacement will be produced in the relative positional relationship between the XY stage 71 and the holding member 41 at the time when the relative position of the wafer table WT and the XY stage 71 is adjusted by driving the actuator in order to adjust the position and attitude of the wafer. This displacement is sensed by the control apparatus based on the measurement result of the sensor 47 and the relative positional relationship of the XY stage 71 and the holding member 41 stored in advance. Then, the control apparatus appropriately selects and drives the Z motor, Y motor 78, and X linear motor 70 of the aforementioned drive apparatus 79 in order to correct this displacement. Through this, the relative positional relationship between the holding member 41 and the XY stage 71 is held (maintained).

In this way, in the present embodiment as well, in the case in which the wafer stage WST has moved, it is possible to always fixedly maintain the relative positional relationship between the holding member 41 and the XY stage 71, so it is possible to fixedly maintain the shape (bending status) of a utilities supply member TB connected between the holding member 41 and the XY stage 71, and it is possible to restrict stress produced by the deformation of [sic] said utilities supply member TB deforming from being transmitted to the XY stage 71 and exerting an adverse influence upon the positioning accuracy of the wafer held by the wafer table WT.

In the above, optimal embodiments relating to the present invention have been described while referring to the attached drawings, but the present invention is, of course, not limited to the relevant examples. The various shapes and combinations of the respective constituent members indicated in the examples discussed above are merely examples, and various modifications are possible based on design requirements, etc. within a scope in which the gist of the present invention is not deviated from.

For example, in the aforementioned embodiments, the relative position between the holding part and the utilities supply target (the second member) is monitored with six degrees of freedom, and the drive apparatus controls the position of the holding part with six degrees of freedom. However, it is not limited to the six degrees of freedom. In the case in which the movement of the utilities supply target (the second member) is allowed to move with three degrees of freedom, the position of the holding part can be controlled with three degrees of freedom. In the case in which the holding part needs not to follow a movement of the second member in a predetermined direction among the degrees of freedom being allowed for the second member, the number of the degrees of freedom for controlling the position of the holding part can be less than the number of the degrees of freedom being allowed for the second member.

Furthermore, in the aforementioned fourth embodiment, a description was given with respect to a configuration in which the holding member 41, which holds a utilities supply member TB between a wafer stage and a tube carrier, is provided, but it is not limited to these, and the configuration may also be such that, for example, the utilities supply member TB is held with a tube carrier 76 as the support apparatus relating to the present invention and, in addition to it being possible to drive the tube carrier 76 in the X directions with respect to the X linear motor 70 with a long stroke, it is possible to drive with a fine stroke in the Z directions, the Y directions, the θZ directions, the θY directions and the θX directions respectively, and the configuration may also be such that the tube carrier 76 is driven so that the relative positional relationship between the tube carrier 76 and the XY stage 71 is maintained according to the measurement result of the sensor that measures the relative positional relationship with the XY stage 71 provided on the tube carrier 76.

By employing this configuration, it is possible to fixedly maintain the shape (bending status) of the utilities supply member TB between the XY stage 71 and the tube carrier 76, and it is possible to restrict stress produced by the deformation of [sic] said utilities supply member TB deforming from being transmitted to the XY stage 71 and exerting an adverse effect upon the positioning accuracy of the wafer held by the wafer table WT.

In addition, in the above embodiment, a configuration in which the utilities supply member is connected between the metrology frame 15 and the main body column CL and a configuration in which it is connected between the wafer stage and the tube carrier were described, but it is not limited to these, and it is also applicable to, for example, the case in which the utilities supply member is connected between the reticle base (base member) 31 shown in FIG. 1 and the main body column CL and the case in which the utilities supply member is connected between the pedestal 7A, as the base frame, and the wafer base plate (base member) WB.

Specifically, in a case in which the utilities supply member is connected between the reticle base 31 and the main body column CL, by supporting a holding member, which holds the utilities supply member, to be able to move to the main body column CL, while providing a measuring apparatus that obtains the relative position information (measures a parameter related to the relative position) of the reticle base 31 and the holding member and driving the holding member based on the measurement result of the measuring apparatus, it is possible to always fixedly maintain the relative positional relationship of the reticle base 31 and the holding member 41, so the shape (bending status) of the utilities supply member connected between the reticle base 31 and said holding member can be fixedly maintained, and it is possible to restrict stress produced by said utilities supply member deforming from being transmitted to the reticle base 31 and exerting an adverse influence upon the movement characteristics and positioning accuracy of the reticle R held by the reticle stage RST.

In addition, in the case in which the utilities supply member is connected between pedestal 7A and the wafer base plate WB, by movably supporting the holding member, which holds the utilities supply member, on the pedestal 7A while providing a measuring apparatus, which obtains the relative position information of pedestal 7A and said holding member, and driving the holding member based on the measurement result of the measuring apparatus, it is possible to always fixedly maintain the relative positional relationship of the wafer base plate WB and the holding member, so it is possible to fixedly maintain the shape (bending status) of the utilities supply member connected between the wafer base plate WB and said holding member, and it is possible to restrict stress produced by said utilities supply member deforming from being transmitted to the wafer base plate WB and exerting an adverse influence upon the movement characteristics and positioning accuracy of the wafer held by the wafer stage WST.

In addition, in the above first through third embodiments, the configuration was such that the position of the fixed part 16, which fixes the utilities supply member TB at the metrology frame 15, was measured using the sensor 47, but it is not limited to this, and the configuration may also be such that, if it is possible to measure the relative position of the metrology frame 15 with respect to the holding member 41, a prescribed position set on the metrology frame 15 and a mark provided on the metrology frame 15 are measured.

Note that applicable as the substrate (object) of the respective aforementioned embodiments are not only semiconductor wafers W for semiconductor device manufacture but glass substrates for display devices, ceramic wafers for thin film magnetic heads, the original plates (synthetic quartz, silicon wafer), etc. of masks or reticles used in exposure apparatuses, or a film member or the like. In addition, the shape of the substrate is not limited to being a circular shape, and may be another shape such as a rectangle or the like.

For the exposure apparatus, in addition to step-and-scan system scanning type exposure apparatuses (scanning steppers) that synchronously move the reticle R and the wafer W to scan expose the pattern of the reticle R, application is possible to step-and-repeat system projection exposure apparatuses (steppers) that full-field expose the pattern of a reticle R in a status in which the reticle R the wafer W have been made stationary and sequentially step move the wafer W. In addition, application is possible to step-and-stitch system exposure apparatuses that partially superpose and transfer at least two patterns on the wafer W.

The type of exposure apparatus is not limited to exposure apparatuses for the manufacture of semiconductor devices that expose a semiconductor device pattern on a wafer W, and broad application to exposure apparatuses for liquid crystal display element manufacture or display manufacture and exposure apparatuses for the manufacture of thin film magnetic heads, image pickup elements (CCDs), micromachines, MEMS, DNA chips, or reticles or masks is also possible.

In addition, for the light source of the exposure apparatus to which the present invention is applied, it is possible to use not only KrF excimer lasers (248 nm), ArF excimer lasers (193 nm) and F₂ lasers (157 nm) but g lines (436 nm) and i lines (365 nm). Moreover, the magnification of the projection optical system may be not only a reduction system but any of a unity magnification system or an enlargement system. In addition, in the aforementioned embodiment, an example was given of a catadioptric type projection optical system, but it is not limited to this, and it is also applicable to a dioptric projection optical system set at a position at which the optical axis (reticle center) of the projection optical system and the center of the projection region differ.

In addition, the present invention is applied to a so-called liquid immersion exposure apparatus that locally fills liquid between the projection optical system and the substrate and exposes the substrate via the liquid, and there are disclosures with respect to liquid immersion exposure apparatuses in the PCT International Patent Publication No. WO 99/49504. In addition, the present invention may also be applied to a liquid immersion exposure apparatus that performs exposure in a status in which the entire surface of the substrate that is to be exposed is immersed in liquid, such as those disclosed in Japanese Unexamined Patent Application Publication No. H6-124873, Japanese Unexamined Patent Application Publication No. H10-303114, and U.S. Pat. No. 5,825,043.

In addition, the present invention can also be applied to twin-stage type exposure apparatuses in which a plurality of substrate stages (wafer stages) are provided. The structure and the exposure operations of twin-stage type exposure apparatuses are disclosed in, for example, Japanese Unexamined Patent Application Publication No. H10-163099, Japanese Unexamined Patent Application Publication No. H10-214783 (corresponds to U.S. Pat. Nos. 6,341,007, 6,400,441, 6,549,269 and 6,590,634), Published Japanese Translation No. 2000-505958 of PCT International Application (corresponds to U.S. Pat. No. 5,969,441) and U.S. Pat. No. 6,208,407. In addition, the present invention may also be applied to the wafer stage of Patent Application No. 2004-168481 previously applied for by the applicant of the present application.

In addition, the exposure apparatus is manufactured by assembling various subsystems, including the respective constituent elements, so that the prescribed mechanical precision, electrical precision and optical precision are maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the exposure apparatus includes mechanical connections, electrical circuit wiring connections, air pressure circuit piping connections, etc. among the various subsystems. Obviously, before the process of assembly from these various subsystems to the exposure apparatus, there are the processes of individual assembly of the respective subsystems. When the process of assembly of the various subsystems into the exposure apparatus has ended, overall adjustment is performed, and the various precisions are ensured for the exposure apparatus as a whole. Note that it is preferable that the manufacture of the exposure apparatus be performed in a clean room in which the temperature, the degree of cleanliness, etc. are controlled.

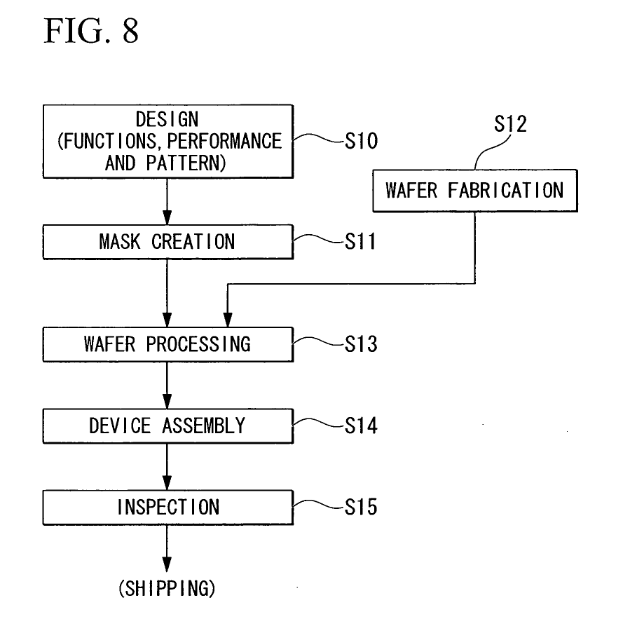

Next, an exposure apparatus and exposure method will be described with respect to an embodiment of a microdevice manufacturing method used in a lithography process. FIG. 8 is a drawing that shows a flow chart of a microdevice (semiconductor chip such as IC or LSI, liquid crystal panel, CCD, thin film magnetic head, micromachine, etc.) manufacturing example.

First, in step S10 (design step), function and performance design (for example, circuit design of a semiconductor device) of a microdevice are performed, and pattern design for achieving those functions is performed. Then, in step S11 (mask creation step), a mask (reticle) on which the designed circuit pattern is formed is created. While, in step S12 (wafer fabrication step), a wafer is fabricated using a material such as silicon.

Next, in step S13 (wafer processing step), the mask and wafer prepared in step S10˜step S12 are used to form the actual circuit on the wafer, etc. by lithography technology, etc. as discussed below. Next, in step S14 (device assembly step), the wafer processed in step S13 is used to perform device assembly. In this step S14, processes such as a dicing process, a bonding process, and a packaging process (chip sealing) are included as necessary. Lastly, in step S15 (inspection step), inspections such as an operation confirmation test and a durability test for the microdevice manufactured in step S14 are performed. Having passed through these processes, the microdevices are completed and shipped.

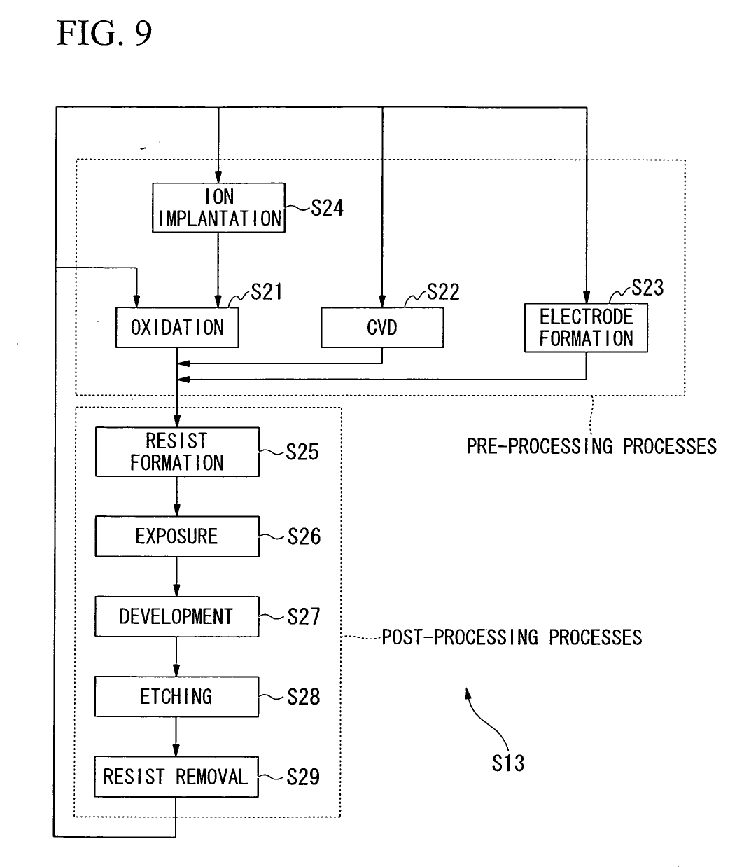

FIG. 9 is a drawing that shows an example of the detailed flow of step S13 in the case of a semiconductor device.

The surface of the wafer is oxidized in step S21 (oxidation step). In step S22 (CVD step), an insulation film is formed on the wafer surface. In step S23 (electrode formation step), an electrode is formed on the wafer by vapor deposition. In step S24 (ion implantation step), ions are implanted in the wafer. The respective steps above, step S21˜step S24, constitute the pre-processing processes of the respective stages of wafer processing, and they are selected and executed according to the processes required for the respective stages.

In the respective stages of the wafer process, when the above pre-processing processes have ended, post-processing processes are executed in the following way. In these post-processing processes, first, in step S25 (resist formation step), the wafer is coated with a photosensitive agent. Then, in step S26 (exposure step), the circuit pattern of the mask is transferred to the wafer by the lithography system (exposure apparatus) and exposure method described above. Then, in step S27 (development step), the exposed wafer is developed, and, in step S28 (etching step), the exposed members of portions other than the portions where resist remains are removed by etching. Then, in step S29 (resist removal step), etching is completed, and the resist that has become unnecessary is removed. By repeatedly performing these pre-processing processes and post-processing processes, circuit patterns are multiply formed onto the wafer.

In addition, the present invention can also be applied not only to microdevices such as semiconductor devices but to exposure apparatuses that transfer a circuit pattern from a mother reticle to glass substrates, silicon wafers, etc. in order to manufacture reticles or masks used in optical exposure apparatuses, EUV exposure apparatuses, x-ray exposure apparatuses and electron beam exposure apparatuses. Here, in exposure apparatuses that use DUV (deep ultraviolet) light or VUV (vacuum ultraviolet) light, in general, transmittance type reticles are used, and, quartz glass, quartz glass doped with fluorine, fluorite, magnesium fluoride or liquid crystal is used for the reticle substrate. Also, in proximity system x-ray exposure apparatuses or electron beam exposure apparatuses, transmittance type masks (stencil masks, membrane masks) are used, and a silicon wafer, etc. is used as the mask substrate. Note that such exposure apparatuses are disclosed in PCT International Publication Nos. WO99/34255, WO99/50712, WO99/66370, Japanese Unexamined Patent Application Publication No. H11-194479, Japanese Unexamined Patent Application Publication No. 2000-12453, and Japanese Unexamined Patent Application Publication No. 2000-29202.

As far as is permitted, the disclosures in all of the patent Publications and U.S. patents related to exposure apparatuses and the like cited in the above respective embodiments and modified examples, are incorporated herein by reference.

What is claimed is:

1. A connection apparatus for a utilities supply member, comprising:
a holding part, which is supported to freely move relative to a first member and holds a part of the utilities supply member connected between the first member and a second member,
a drive apparatus, which moves the holding part relative to the first member,
a measuring apparatus, which obtains information relating to the relative position between the holding part and the second member, and
a control apparatus, which controls the drive apparatus based on the measurement results of the measuring apparatus.

2. A connection apparatus according to claim 1, wherein the first member comprises a main body part and a mass body, which is connected to the main body part via an elastic body, and holds another part of the utilities supply member.

3. A connection apparatus according to claim 2, wherein the mass body has a manifold apparatus or a cable connector, which relays the utilities supply member.

4. A connection apparatus according to claim 1, wherein the drive apparatus drives the holding part so as to maintain the relative position with respect to the second member.

5. A connection apparatus according to claim 1, wherein the drive apparatus drives the holding part with six degrees of freedom.

6. A connection apparatus according to claim 5, further comprising: a support apparatus, which is provided in a hanging manner on the first member and has an urging force corresponding to the dead load of the holding part to support the holding part.

7. A connection apparatus according to claim 6, wherein the support apparatus has a cylinder part, which is linked to the first member, and a piston part, which is linked to the holding part, at least part of the piston part being inserted into the interior of the cylinder part, and the piston part being movable relative to the cylinder part.

8. A connection apparatus according to claim 6, wherein the support apparatus has an elastic member whose one end is connected to the first member and whose other end is connected to the holding part.

9. A connection apparatus according to claim 8, wherein the characteristic frequency of a vibration system formed by the elastic member and the holding part is smaller than the response frequency of the drive apparatus.

10. A connection apparatus according to claim 1, wherein the drive apparatus drives the holding part without contact.

11. A connection apparatus according to claim 1, wherein the second member is supported by the first member via a vibration isolating apparatus.

12. A stage apparatus comprising:
a base frame, which supports a base member;
a movable stage, which moves above the base member; and
a connection apparatus according to claim 1, which is for connecting a utilities supply member between the base frame and the base member.

13. A stage apparatus comprising:
a movable stage;
a substage, which moves synchronously with the movable stage; and
a connection apparatus according to claim 1, which is for connecting a utilities supply member between the movable stage and the substage.

14. A support apparatus of a projection optical system, comprising:
a base member, which supports the projection optical system;
a base frame, which supports the base member; and
a connection apparatus according to claim 1, which is for connecting a utilities supply member between the base frame and the base member.

15. An exposure apparatus that comprises a stage apparatus according to claim 12.

16. An exposure apparatus that comprises a stage apparatus according to claim 13.

17. An exposure apparatus that comprises a support apparatus according to claim 14.
